(19) United States
(12) Patent Application Publication
(10) Pub. No.: US 2024/0419908 A1
(43) Pub. Date: Dec. 19, 2024

(54) APPLICATION OF NATURAL LANGUAGE PROCESSING TO FACILITATE RESPONSES TO REGULATORY QUESTIONS

(71) Applicant: AMGEN INC., Thousand Oaks, CA (US)

(72) Inventors: Saleh Alkhalifa, Medford, MA (US); Daniel Vagle, Boston, MA (US); Furkan Ozyurt, Boston, MA (US); Elif Seyma Bayrak, Medford, MA (US)

(21) Appl. No.: 18/702,713

(22) PCT Filed: Oct. 18, 2022
(86) PCT No.: PCT/US22/46974

§ 371 Date: Apr. 18, 2024

Related U.S. Application Data
(60) Provisional application No. 63/270,448, filed on Oct. 21, 2021.
(60) Provisional application No. 63/389,569, filed on Jul. 15, 2022.

(51) Int. Cl. G06F 40/284; G06F 40/205

(52) U.S. Cl. CPC G06F 40/284; G06F 40/205

(57) ABSTRACT

In systems and methods for processing regulatory questions, textual data representing regulatory questions is obtained by one or more processors. The systems and methods also use one or more natural language processing models to classify the regulatory questions, generate answers to the regulatory questions, generate summaries of the regulatory questions, and/or identify documents that are similar to the regulatory questions. The systems and methods also store, transmit, and/or display data indicative of the classifications, answers, summaries, and/or similar documents.

### FIELD OF DISCLOSURE

The present application relates generally to technologies for expediting regulatory processes, and more specifically to systems and methods for classifying questions in regulatory documents (e.g., health assessment questionnaires (HAQs) or responses to questions (RTQs)), e.g., in order to more efficiently respond to such questions.

### BACKGROUND

Developed countries have established regulatory authorities (e.g., the Food and Drug Administration in the U.S.) that rigorously review the safety and efficacy of products provided by entities such as pharmaceutical or medical device companies. To make their assessments, these regulatory authorities typically require extensive data. To this end, the pharmaceutical or other companies are typically required to submit various documents, and the regulatory authorities in turn issue documents that request additional data. These regulatory documents (e.g., health assessment questionnaire (HAQ) or response to questions (RTQ) documents) can include many (e.g., hundreds) of detailed questions, making it extremely time consuming to provide complete and accurate answers.

One very significant source of delay is the initial stage in which reviewers must scan through all the questions in order to determine which ones they are able and/or most qualified to answer. For example, a person whose primary experience is with drug labeling may not be able to easily answer questions relating to clinical testing or safety. Once an inquiry is directed to the appropriate user, additional delay results from the time it takes for the user to fully understand what information is being sought. For example, an inquiry may be quite long (e.g., multiple paragraphs), and/or may be expressed as a description (e.g., describing a particular problem/issue) rather than an explicit question. Once the user understands the inquiry, still further delays may result from the time it takes the user and/or others to determine the appropriate answer/response. These sorts of delays are costly not only in the sense that they consume employee man-hours, but also in the sense that they can lengthen the overall regulatory approval process. Moreover, manual reviews can be error-prone, e.g., with users sometimes skipping over or ignoring questions that are in fact relevant to those users' skill sets or experience, or with users initially misunderstanding a question, etc., thereby leading to additional delays.

### SUMMARY

Embodiments described herein relate to systems and methods that improve efficiency, consistency, and/or accuracy when processing questions of the sort found in regulatory documents (e.g., HAQs, RTQs, etc.), and/or generating responsive regulatory submissions. As used herein, and unless the context of use indicates a more specific meaning, terms such as “question,” “inquiry,” and “query” may refer to either an explicit question (e.g., “What is the maximum dosage of Drug X?”) or an implicit question or prompt (e.g., describing a potential problem with the administration of Drug X, with it being understood that a response should explain why that problem is of no concern or how the problem has been mitigated, etc.), and may refer to a single sentence or a set of related sentences (e.g., “Drug Y is known to be associated with Condition Z. How frequently has this condition occurred in test trials?”). Moreover, while reference is made herein to “regulatory documents” that may be the source of a particular question under consideration, it is understood that questions may be sourced in other ways, such as by users (e.g., by cutting-and-pasting a regulatory question into a user interface, or by manually entering an anticipated future regulatory question, etc.). As used herein, the term “document” may be any electronic document or portion thereof (e.g., an original PDF, a PDF that is a scanned version of a paper document, a Word document, etc.), and more generally may be any collection of textual data that represents the question(s) or other sentences and/or sentence fragments therein.

Generally, the techniques disclosed herein make use of natural language processing (NLP) and semantic searching to process regulatory questions and provide certain outputs that can facilitate users' preparation of regulatory responses. To provide more accurate/useful results, these techniques can make use of deep learning models (i.e., neural networks). The neural networks can in some embodiments provide contextual embeddings and/or bidirectional “reading” of text inputs (e.g., considering the ordering of words in both directions in order to better understand the relationships of words within a question), rather than more simplistic approaches such as keyword searching. Moreover, scientific language/knowledge that is particularly relevant to regulatory documents (e.g., pharmaceutical regulatory documents) can be incorporated into the deep learning models at the training stage in order to make the models more useful in this context.

In some embodiments, systems and methods disclosed herein automatically classify regulatory questions to facilitate the process of generating responses to those questions. For example, a classification unit may pre-process the text (e.g., by parsing into questions, removing irrelevant words, tokenizing, etc.), and then use an NLP model to classify each question into a category that helps users identify who is best suited to provide an answer. Example categories may include “Clinical,” “Safety,” “Regulatory,” and/or other suitable labels. In this manner, regulatory questions can be more quickly and accurately paired with the appropriate personnel, thereby shortening the process of providing a regulatory authority with a full set of responses, and potentially shortening the regulatory approval process as a whole. This disclosure also describes specific NLP model types or architectures that are particularly well-suited to the task of classifying regulatory documents. In some embodiments, a neural network that employs at least one bidirectional layer (e.g., a long short-term memory (LSTM) neural network) performs the classification task. In other embodiments, however, classification is performed by a neural network that would typically not even be considered for use in the field of textual understanding or classification. In particular, in some embodiments, a deep feed-forward neural network classifies each question into the appropriate category. This approach has been determined to work well despite its relative simplicity (i.e., lack of bidirectionality), and works well with a small number of layers (e.g., only one pooling layer and only two dense layers). By virtue of its simplicity, the deep feed-forward neural network can be trained and validated, and perform classification, far faster than other classification models. For example, the deep feed-forward neural network can operate (during training, validation, and at run-time) at speeds approximately 30 times (or more) higher than bidirectional neural networks.

In other embodiments, systems and methods disclosed herein automatically identify one or more past/historical questions that are similar to a question currently under consideration. For example, a similarity unit may use an NLP model to process/analyze questions, retrieve similar questions from a historical database, and determine confidence scores indicating the degree of similarity for each. A user may then review the most similar questions to better understand the question under consideration, and/or see whether the answers/responses to the historical questions are useful in the current case. The similarity unit may pre-process the text of the regulatory question, e.g., as discussed above for the classification unit.

In other embodiments, systems and methods disclosed herein generate answers to a regulatory question currently under consideration. For example, an answer generation unit may use one or more NLP models to process/analyze questions and automatically generate one or more potential answers. The answer generation unit may identify relevant historical answers by first identifying similar questions, e.g., by applying the similarity unit as discussed above. A user may then consider whether to incorporate (wholly or partially) any of the generated potential answers in the submitted regulatory response. The answer generation unit may pre-process the text of the regulatory question, e.g., as discussed above for the classification unit.

In other embodiments, systems and methods disclosed herein automatically summarize regulatory questions. For example, a summarizer unit may use one or more NLP models to process a relatively lengthy regulatory question (e.g., two or three paragraphs, possibly not framed as an explicit question), and output a more concise version of the question (e.g., one or two lines expressed as an explicit question). Summarizing regulatory questions in this manner can enable a user to understand and/or classify each question more quickly. The summarizer unit may pre-process the text of the regulatory question, e.g., as discussed above for the classification unit.

In still other embodiments, some or all of the embodiments noted above are used together, e.g., in a pipeline, parallel, or hybrid pipeline/parallel architecture. For example, systems and methods disclosed herein may input a question into a classification unit, and then input the same question into similarity and answer generation units that are specific to the classification that was output by the classification unit. The similarity unit may then identify similar historical questions and the answer generation unit may propose an answer/reply to the question. In other embodiments and/or scenarios, the various units (classification, similarity, answer generation, or summarizer) are used independently.

### BRIEF DESCRIPTION OF THE DRAWINGS

The skilled artisan will understand that the figures, described herein, are included for purposes of illustration and do not limit the present disclosure. The drawings are not necessarily to scale, and emphasis is instead placed upon illustrating the principles of the present disclosure. It is to be understood that, in some instances, various aspects of the described implementations may be shown in a simplified, exaggerated, or enlarged manner in order to facilitate an understanding of the described implementations. In the drawings, like reference characters throughout the various drawings generally refer to functionally similar and/or structurally similar components.

FIG. 1 is a block diagram of an example system that may implement the techniques described herein.

FIG. 2 depicts an example pipeline embodiment of the techniques described herein.

FIG. 3 depicts an example process that may be implemented by the regulatory document response facilitator application of FIG. 1.

FIG. 4 depicts an example deep feed-forward neural network that may be implemented by the classification unit in the system of FIG. 1.

FIGS. 5A-C depict plots of performance achieved by the deep feed-forward neural network of FIG. 4.

FIG. 6 depicts an example bidirectional neural network that may be implemented by the classification unit in the system of FIG. 1.

FIGS. 7A-C depict example user interfaces that may be presented on the display device in the system of FIG. 1.

FIG. 8 is a flow diagram of an example method for classifying regulatory questions.

FIG. 9 is a flow diagram of an example method for identifying documents similar to a regulatory question.

FIG. 10 is a flow diagram of an example method for generating potential answers to a regulatory question.

FIG. 11 is a flow diagram of an example method for summarizing a regulatory question.

### DETAILED DESCRIPTION

The various concepts introduced above and discussed in greater detail below may be implemented in any of numerous ways, and the described concepts are not limited to any particular manner of implementation. Examples of implementations are provided for illustrative purposes.

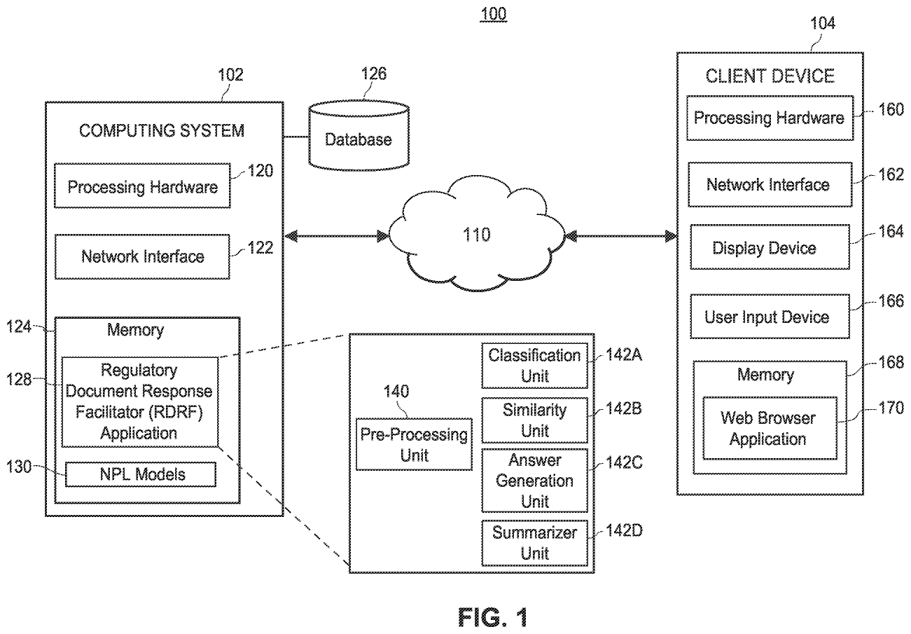

FIG. 1 is a block diagram of an example system 100 that may implement the techniques described herein. The system 100 includes a computing system 102 communicatively coupled to a client device 104 via a network 110. The computing system 102 (e.g., a server) is generally configured to train one or more machine learning models that perform natural language processing (NLP), and use the NLP model(s) to process regulatory documents (e.g., specific regulatory questions) for one or more purposes as discussed in further detail below. The client device 104 is generally configured to enable a user, who may be remote from the computing system 102, to make use of the regulatory document processing capabilities of the computing system 102, and to provide various interactive capabilities to the user as discussed further below. The network 110 may be a single communication network, or may include multiple communication networks of one or more types (e.g., one or more wired and/or wireless local area networks (LANs), and/or one or more wired and/or wireless wide area networks (WANs) such as the Internet). While FIG. 1 shows only one client device 104, other embodiments may include any number of different client devices communicatively coupled to the computing system 102 via the network 110. In particular, the client device 104 and a number of other client devices may utilize the regulatory document/question processing capabilities of the computing system 102 as a “cloud” service. Alternatively, the computing system 102 may be a local server or set of servers, or the client device 104 may include the components and functionality of the computing system 102 in order to perform the regulatory document processing tasks itself. In the latter case, the system 100 may omit the computing system 102 and the network 110. In still other embodiments, one, some, or all of the NLP model(s) is/are trained by another system or device, not shown in FIG. 1, before being provided to the computing system 102 or client device 104.

As seen in FIG. 1, the computing system 102 includes processing hardware 120, a network interface 122, and memory 124. In some embodiments, however, the computing system 102 includes two or more computers that are either co-located or remote from each other. In these distributed embodiments, the operations described herein relating to the processing hardware 120, the network interface 122, and/or the memory 124 may be divided among multiple processing units, network interfaces, and/or memories, respectively. The computing system 102 is communicatively coupled (directly, or via one or more networks and/or computing devices/systems not shown in FIG. 1) to a database 126. The database 126 may be one or more databases stored in one or more local or distributed memories. Collectively, the database 126 contains data that may be used to train machine learning models (e.g., the NLP models 130 discussed below), as well as an archive of past regulatory questions and their answers (e.g., answers manually developed/generated by users having the appropriate knowledge, experience, and job responsibilities). In some embodiments, however, one or more of the NLP models 130 is trained using data external to the database 126, such as textual data that is collected/scraped from the websites, social media services, and/or one or more other sources.

The processing hardware 120 includes one or more processors, each of which may be a programmable microprocessor that executes software instructions stored in the memory 124 to execute some or all of the functions of the computing system 102 as described herein. The processing hardware 120 may include one or more central processing units (CPUs) and/or one or more graphics processing units (GPUs), for example. In some embodiments, some of the processors in the processing hardware 120 may be other types of processors (e.g., application-specific integrated circuits (ASICs), field-programmable gate arrays (FPGAs), etc.).

The network interface 122 may include any suitable hardware (e.g., front-end transmitter and receiver hardware), firmware, and/or software configured to communicate with the client device 104 (and possibly other client devices) via the network 110 using one or more communication protocols. For example, the network interface 122 may be or include an Ethernet interface, enabling computing system 102 to communicate with the client device 104 and other client devices over the Internet or an intranet, etc.

The memory 124 may include one or more volatile and/or non-volatile memories. Any suitable memory type or types may be included, such as read-only memory (ROM), random access memory (RAM), flash memory, a solid-state drive (SSD), a hard disk drive (HDD), and so on. Collectively, the memory 124 may store one or more software applications, the data received/used by those applications, and the data output/generated by those applications. These applications include a regulatory document response facilitator (RDRF) application 128 that, when executed by the processing hardware 120, processes regulatory documents/questions and outputs/displays information in a way that facilitates the generation of responses to those documents/questions. For example, as discussed further below, the RDRF application 128 may classify regulatory questions under consideration, identify other documents (e.g., other regulatory questions) that are similar to the questions under consideration, generate answers to the questions under consideration, and/or summarize the questions under consideration. While various software components of the RDRF application 128 are discussed below using the term “unit,” it is understood that this term is used in reference to a particular type of software functionality. The various software units shown in FIG. 1 may instead be distributed among two or more different software applications, and/or the functionality of any single software unit may be divided among two or more software applications. Moreover, two or more of the depicted software units may be implemented by a single software module, and/or two or more of the depicted software units may share certain modules/libraries/resources/etc. The memory 124 also stores one or more NLP models 130 that is/are utilized by (and is/are possibly a part of) the RDRF application 128.

In general, a pre-processing unit 140 of the RDRF application 128 performs one or more operations on the textual data (e.g., data files) containing the regulatory question(s), such as parsing the data into different questions, removing words that are irrelevant to later processing, and/or other suitable operations. The RDRF application 128 also includes a number of software units that perform the primary processing tasks of the RDRF application 128, including (in the embodiment shown in FIG. 1) a classification unit 142A, a similarity unit 142B, an answer generation unit 142C, and a summarizer unit 142D. In other embodiments, the RDRF application 128 includes only one, two, or three of the units 142A-D, and/or includes other processing units not shown in FIG. 1. In some embodiments, some or all of the functions of the pre-processing unit 140 are specific to a particular one of the units 142A-D. For example, the similarity unit 142B may not require the same pre-processing steps as the summarizer unit 142D.

The classification unit 142A generally applies one or more of the NLP models 130 to the textual data (e.g., to pre-processed textual data) in order to determine the appropriate category for each regulatory question represented by the textual data. The RDRF application 128 stores, transmits (e.g., to client device 104 or another computing device or system not shown in FIG. 1), and/or displays (e.g., locally and/or at client device 104) data indicative of the determined categories. For example, the RDRF application 128 may locally store the determined categories (e.g., in the memory 124), and then transmit the stored categories to a client device (e.g., client device 104) to cause the client device to display those categories (or to cause the client device to display the questions in a manner that otherwise reflects their determined categories, etc.), or transmit the stored categories to a printer device to cause the printer device to print an indication of the categories, etc. As another example, the RDRF application 128 may directly display the categories at the computing system 102.

The similarity unit 142B generally applies one or more of the NLP models 130 to the textual data (or to pre-processed textual data) in order to identify one or more documents (e.g., other, past/historical questions) that are most similar to a particular regulatory question as represented by the textual data. The similarity unit 142B may identify similar documents from among those contained in database 126, for example. The RDRF application 128 stores, transmits (e.g., to client device 104 or another computing device or system not shown in FIG. 1), and/or displays (e.g., locally and/or at client device 104) data indicative of the identified similar document(s). For example, the RDRF application 128 may locally store the data indicative of the identified document(s) (e.g., in the memory 124), and then transmit the stored data to a client device (e.g., client device 104) to cause the client device to display information about those documents (e.g., title, an extract, etc.), or transmit the stored data to a printer device to cause the printer device to print such information, etc. As another example, the RDRF application 128 may directly display the data/information at the computing system 102.

The answer generation unit 142C generally applies one or more of the NLP models 130 to the textual data (or to pre-processed textual data) in order to generate one or more potential answers to a particular regulatory question as represented by the textual data. In some embodiments, the answer generation unit 142C utilizes similarity unit 142B (or implements functionality similar to similarity unit 142B) to find documents in database 126 that are similar to a particular regulatory question, and then generates the potential answer(s) based at least in part on the textual content of the similar document(s). In these embodiments, the answer generation unit 142C may generate the potential answers by identifying and extracting portions of the similar documents (e.g., portions of actual answers to past regulatory questions identified by similarity unit 142B), or may synthesize answers without relying (or without entirely relying) on the verbatim text of the similar documents. The RDRF application 128 stores, transmits (e.g., to client device 104 or another computing device or system not shown in FIG. 1), and/or displays (e.g., locally and/or at client device 104) data indicative of the generated answer(s) (e.g., the answer(s) themselves). For example, the RDRF application 128 may locally store generated answers (e.g., in the memory 124), and then transmit the stored answers to a client device (e.g., client device 104) to cause the client device to display the answers, or transmit the stored answers to a printer device to cause the printer device to print the answers, etc. As another example, the RDRF application 128 may directly display the answers at the computing system 102.

The summarizer unit 142D generally applies one or more of the NLP models 130 to the textual data (or to pre-processed textual data) in order to generate a shorter summary of a particular regulatory question as represented by the textual data. In some embodiments, the summarizer unit 142D utilizes similarity unit 142B (or implements functionality similar to similarity unit 142B) to find documents in database 126 that are similar to a particular regulatory question, and then generates a summary based at least in part on the textual content of the similar document(s). The RDRF application 128 stores, transmits (e.g., to client device 104 or another computing device or system not shown in FIG. 1), and/or displays (e.g., locally and/or at client device 104) data indicative of the generated summary (e.g., the summary itself). For example, the RDRF application 128 may locally store the generated summary (e.g., in the memory 124), and then transmit the stored summary to a client device (e.g., client device 104) to cause the client device to display the summary, or transmit the stored summary to a printer device to cause the printer device to print the summary, etc. As another example, the RDRF application 128 may directly display the summary at the computing system 102.

The operation of each of units 142A-D is discussed in further detail below. It is understood that, in some embodiments, each of one, some, or all of the units 142A-D can include two or more NLP models of NLP models 130. In one embodiment, for example, the NLP models 130 includes multiple NLP classification models each specialized to determine whether textual data corresponding to a particular question should, or should not, be classified as belonging to a single, respective category (e.g., with one of NLP models 130 determining whether to classify as “Safety,” another of NLP models 130 determining whether to classify as “Labeling,” etc.), in which case the classification unit 142A may utilize each of those class-specific NLP models to classify each question according to one or more classes/categories. As another example, the answer generation unit 142C may include a first one of NLP models 130 to identify documents in database 126 that are similar to a particular regulatory question, and a second one of NLP models 130 to generate one or more potential answers to the regulatory question based on the textual content of the identified documents.

The RDRF application 128 may also collect data entered by users via their user interfaces and web browser applications at client devices, and/or detect user activation of controls presented by user interfaces and web browser applications at client devices, as discussed herein with specific reference to client device 104. The client device 104 includes processing hardware 160, a network interface 162, a display device 164, a user input device 166, and memory 168. The processing hardware 160 includes one or more processors, each of which may be a programmable microprocessor that executes software instructions stored in the memory 168 to execute some or all of the functions of the client device 104 as described herein. The processing hardware 160 may include one or more CPUs and/or one or more GPUs, for example. In some embodiments, some of the processors in the processing hardware 160 may be other types of processors (e.g., ASICs, FPGAs, etc.).

The network interface 162 may include any suitable hardware (e.g., a front-end transmitter and receiver hardware), firmware, and/or software configured to communicate with the computing system 102 via the network 110 using one or more communication protocols. For example, the network interface 162 may be or include an Ethernet interface, enabling the client device 104 to communicate with the computing system 102 over the Internet or an intranet, etc.

The memory 168 may include one or more volatile and/or non-volatile memories. Any suitable memory type or types may be included, such as ROM, RAM, flash memory, an SSD, an HDD, and so on. Collectively, the memory 168 may store one or more software applications, the data received/used by those applications, and the data output/generated by those applications. These applications include a web browser application 170 that, when executed by the processing hardware 160, enables the user of the client device 104 to access various web sites and web services, including the services provided by the computing system 102 when executing the RDRF application 128. In other embodiments not represented by FIG. 1 (e.g., in certain embodiments that do not utilize web services), the memory 168 stores and locally executes the RDRF application 128 and NLP models 130.

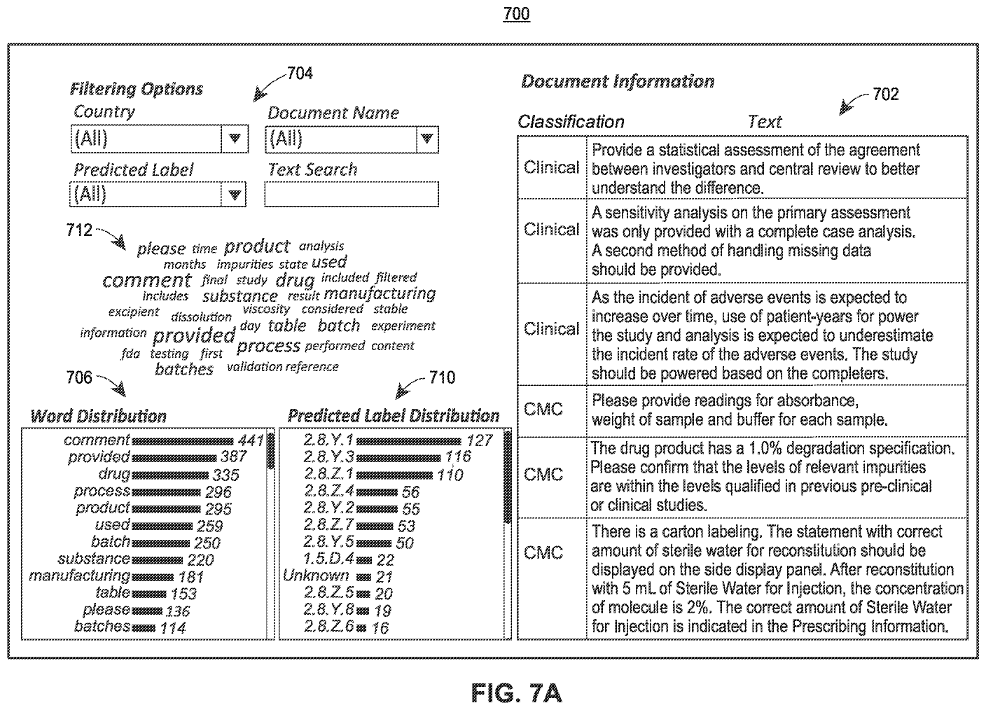

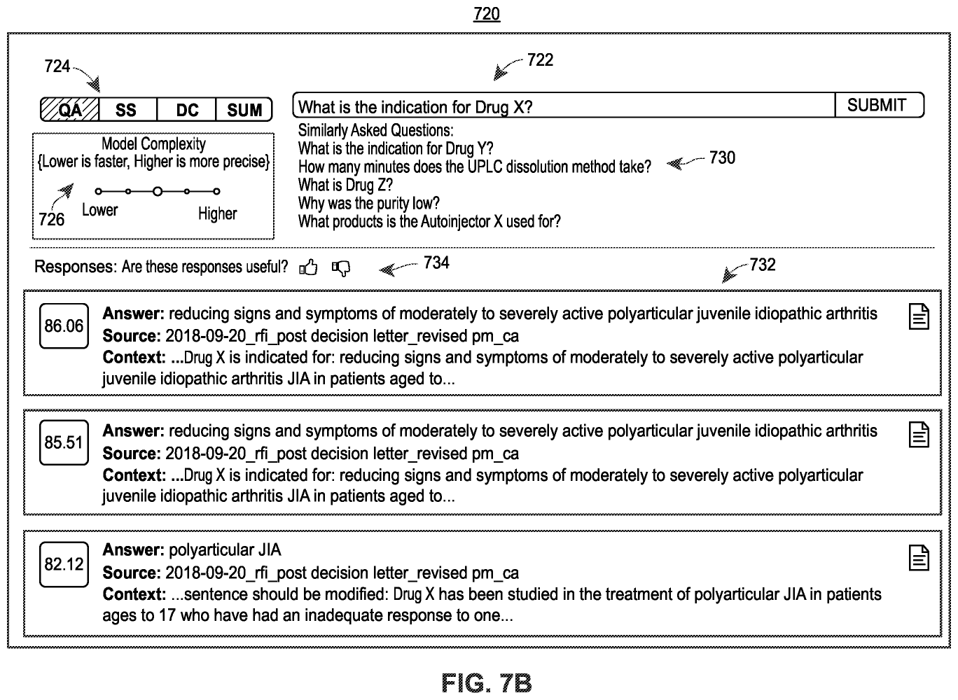

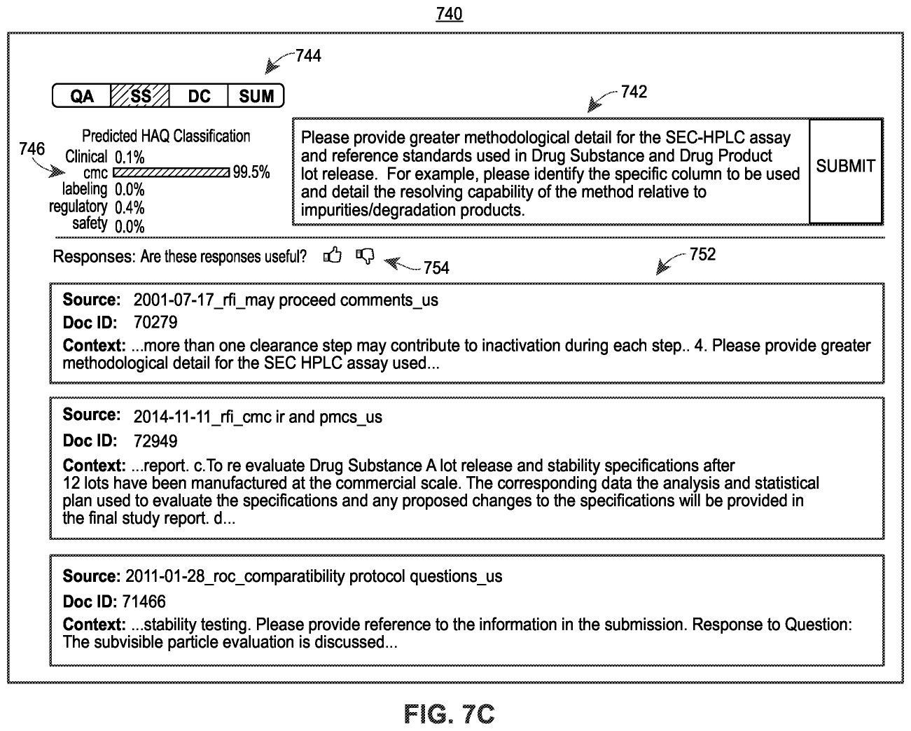

The display device 164 of client device 104 may implement any suitable display technology (e.g., LED, OLED, LCD, etc.) to present information to a user, and the user input device 166 of client device 104 may include a keyboard, microphone, mouse, and/or any other suitable input device(s). In some embodiments, at least a portion of the display device 164 and at least a portion of the user input device 166 are integrated within a single device (e.g., a touchscreen display). Generally, the display device 164 and the user input device 166 may collectively enable a user to interact with user interfaces that enable communication with the RDRF application 128 via a web service (e.g., via the web browser application 170, network interface 162, network 110, and network interface 122) or locally (if the RDRF application 128 and NLP models 130 reside on the client device 104). For example, the user may interact with a user interface in the manner discussed below with reference to any one or more of FIGS. 7A-C.

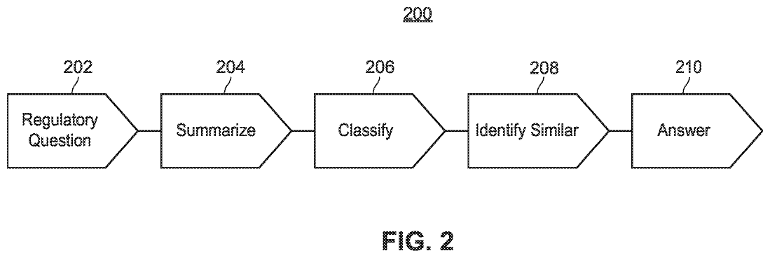

FIG. 2 depicts an example embodiment in which the functionality of the units 142A-D of RDRF application 128 is arranged as a pipeline 200. In the pipeline 200, at stage 202, a particular regulatory question is selected or obtained for consideration. The regulatory question may be a question that was entered by a user in a user interface (e.g., via display device 164 and user input device 166), or a question that the pre-processing unit 140 automatically extracts from a larger document, for example. At stage 204 of the pipeline 200, the summarizer unit 142D summarizes the regulatory question. The RDRF application 128 may cause the summary to be displayed to a user (e.g., via network 110 and display device 164). Also, in the embodiment shown, the summarized version of the regulatory question is classified by the classification unit 142A, at stage 206. In other embodiments, however, the classification unit 142A operates directly on the regulatory question (possibly after pre-processing by pre-processing unit 140), rather than operating on the summary. In either case, the RDRF application 128 may cause the category/classification to be displayed to a user (e.g., via network 110 and display device 164), e.g., by generating/displaying a text label corresponding to the category/classification, or by causing the regulatory question to be displayed in a portion of a user interface that is reserved for a particular category, etc.

At stage 208, the similarity unit 142B identifies one or more documents, from database 126, that are similar to the regulatory question. In the embodiment shown, the classification from stage 206 is used at stage 208. For example, the RDRF application 128 may select and use, at stage 208, an NLP model that is specific to the classification. In other embodiments, however, the similarity unit 142B does not make use of the classification from stage 206, and instead only operates on the regulatory question itself (possibly after pre-processing by pre-processing unit 140). In either case, the RDRF application 128 may cause information pertaining to the similar document(s) to be displayed to a user (e.g., via network 110 and display device 164), e.g., by generating/displaying the name and/or other identifier of the document (e.g., a filename), and/or a portion of text from the document (e.g., at least a portion of the specific text that caused the similarity unit 142B to identify the document).

At stage 210, the answer generation unit 142D generates one or more potential answers to the regulatory question. In the embodiment shown, the similar document(s) from stage 208 is/are used at stage 210 to generate the answer. For example, the similarity unit 142B may use, at stage 208, a first NLP model to identify the similar document(s) in database 126, after which the answer generation unit 142D may analyzed, at stage 210, the textual content of the identified document(s) to extract or synthesize one or more potential answers. The RDRF application 128 may then cause the potential answer(s) to be displayed to a user (e.g., via network 110 and display device 164), possibly along with other information such as an identifier of the document from which the potential answer was derived (e.g., the filename and/or other document identifier), and/or a portion of the text of the document from which the potential answer was derived (e.g., at least a portion of the specific text that the answer generation unit 142D used to generate the answer).

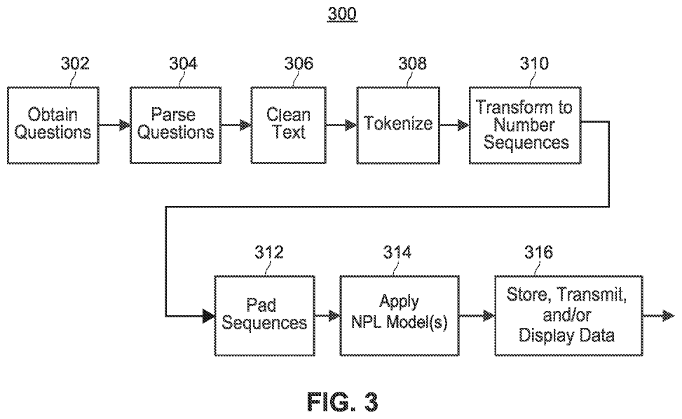

FIG. 3 depicts a process 300 reflecting the run-time operation of the system 100, according to some embodiments. Prior to the run-time operation reflected by the process 300, however, the computing system 102 (or another computing system not shown in FIG. 1) trains and validates the NLP models 130 using data stored in database 126, and/or other data external to the system 100. Some training data may be for unsupervised learning (e.g., to train a model that learns contextualized embeddings of words, as discussed further below), while other training data may include manually-prepared labels for supervised learning (e.g., to train a classification model for the classification unit 142A).

At stage 302 of the process 300, the RDRF application 128 obtains regulatory questions (e.g., questions associated with one or more regulatory documents such as HAQs, RTQs, etc.). For example, the RDRF application 128 may retrieve regulatory documents in PDF or other electronic file formats from a remote or local source, retrieve textual data extracted from one or more larger regulatory documents, receive manually-entered questions, and so on.

At stage 304, the pre-processing unit 140 parses the text into its constituent questions. The pre-processing unit 140 may parse the text into questions using known delimiters or fields in data files that contain the text, based on other formatting of the data files that contain the text (e.g., based on the relative spacing/positioning of text within a PDF file), or using any other suitable technique.

At stage 306, the pre-processing unit 140 cleans the text of the questions by removing words and/or characters that are irrelevant (or should be irrelevant) to the task(s) performed by one or more units of the RDRF application 128 and one or more of the NLP models 130. This may include, for example, removing some or all conjunctions (e.g., “for,” “and,” “nor,” “but,” “or,” “because,” “when,” “while,” etc.), some or all prepositions (e.g., “in,” “under,” “towards,” “before,” etc.), some or all special characters (e.g., semicolons, quotation marks, etc.), and so on. In some embodiments, the pre-processing unit 140 also removes words that have substantive meaning in other contexts but are irrelevant to, or even hinder, the execution of a particular task. For example, if stage 306 is used in preparation for classification by classification unit 142A, the pre-processing unit 140 may remove words that express numbers or are otherwise solely indicative of degree, such as “large” or “3%,” etc.

At stage 308, the pre-processing unit 140 tokenizes the text of the questions (e.g., parses each question into individual words or other linguistic units). At stage 310, the pre-processing unit 140 transforms each token (e.g., each word) of a “cleaned” question into a number, thereby transforming the sequence of words in the question (excepting the words removed at stage 306) into a number sequence. For example, the relatively short question “Provide the detailed performance results showing viscosities greater than 10 cP” may be cleaned and parsed into the words/tokens “provide,” “detailed,” “performance,” “results,” “showing,” “viscosities,” “greater,” “cP,” and those words/tokens may be transformed to the number sequence 125 453 067 012 363 284 138 421. In order to transform all questions into number sequences that have an equal length (i.e., a predetermined, fixed length that is appropriate for one or more of the NLP models 130), at stage 312 the pre-processing unit 140 pads each number sequence as needed. The fixed length may be one that is slightly higher than the number of tokens (after cleaning of the sort performed at stage 306) expected to be present in the longest questions of the regulatory documents, for example.

At stage 314, one or more of the units 142A-D apply one or more of the NLP models 130 to the (possibly padded) number sequences, in order to perform their respective task(s). For example, the classification unit 142 may apply one of the NLP models 130 to the (possibly padded) number sequences, in order to classify the regulatory questions corresponding to those number sequences. At stage 316, the RDRF application 128 stores, transmits, and/or displays data indicative of the output generated by the NLP model(s) 130 (e.g., data indicative of the one or more classifications). For example, if the classification unit 142A operates at stage 314, the computing system 102 may transmit the data to the client device 104, to cause the display device 164 of the client device 104 to display the appropriate category alongside each question, or to cause the display device 164 to display only those questions that are associated with a user-specified category (e.g., a category indicated by the user via the user input device 166, when accessing a user interface via the web browser application 170 or another application, etc.). As another example, the computing system 102 may cause a memory (e.g., a flash device, a portion of the memory 124, etc.) to store the data for later use (e.g., by the computing system 102, the client device 104, and/or another computing device or system), or may cause a printer device to print the data, etc.

The order of the various stages shown in FIG. 3 can vary from that shown, and/or fewer and/or different pre-processing stages may be included, depending on the embodiment and which of the units 142A-D is operating at stage 314. In some embodiments, for example, the pre-processing unit 140 parses questions (stage 304) only after cleaning the text of all questions to remove irrelevant words (stage 306). As another example, the sequence of stages 306, 308, 310, 312, 314, and 316 may repeat on a per-question basis (e.g., as each question is parsed at stage 304, or after all questions have been parsed), or multi-thread processing may enable stages 306, 308, 310, 312, 314, and/or 316 to operate on two or more questions at the same time.

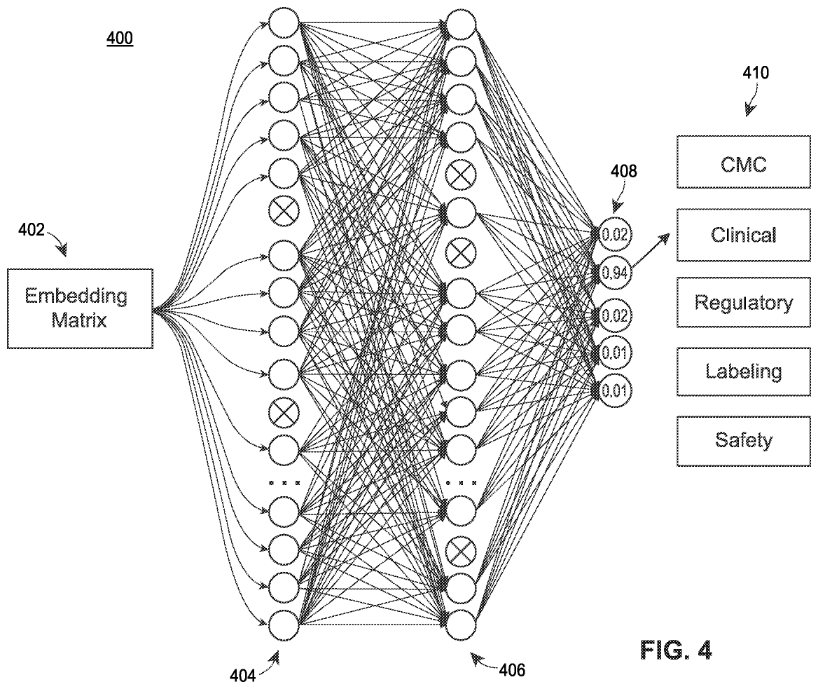

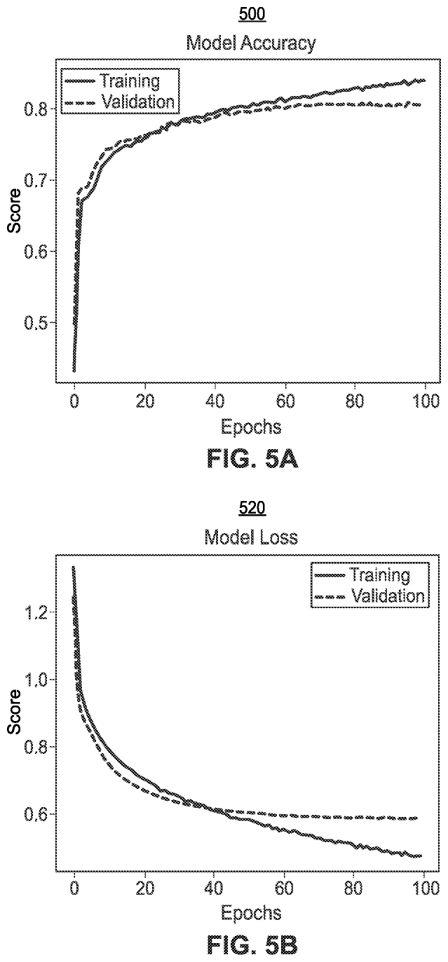

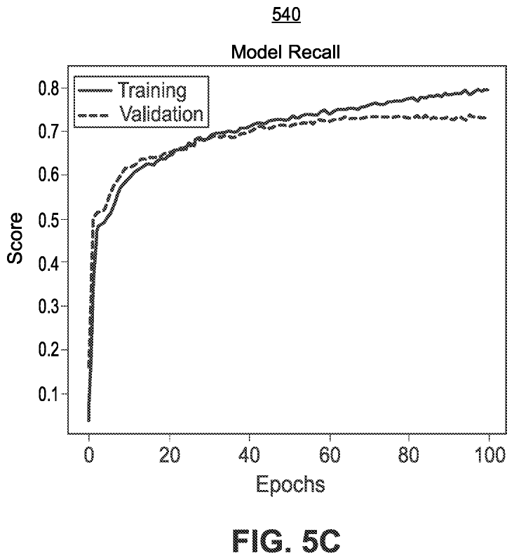

Various embodiments of certain NLP models 130 will now be discussed. Referring first to classification, the classification unit 142A may use an NLP model (of NLP models 130) that is a neural network, and performs a classification task based on words or other tokens (or in other embodiments, as explained above, a set of neural networks that perform respective classification tasks). In the embodiment reflected in FIG. 4, the NLP model used by classification unit 142A is, or includes, a deep feed-forward (DFF) neural network 400. Counter-intuitively, a DFF neural network 400 can work well despite its lack of bidirectionality, which would otherwise indicate that it is not well-suited for text comprehension tasks such as classification. The performance of the DFF neural network 400 is discussed further below with reference to FIGS. 5A-C.

In the DFF neural network 400, an embedding layer generates an embedding matrix 402 from the number sequence generated at stage 310, with one dimension of the embedding matrix 402 being the (post-padding) length of the number sequence (e.g., 5,000, or 10,000, etc.) and the other dimension of the embedding matrix 402 being the input dimension of a global max pooling layer 404 of the DFF neural network 400 (e.g., 128, 256, or another suitable factor of two). In other embodiments, the embedding matrix 402 is three-dimensional. The DFF neural network 400 includes a first dense layer 406 after the global max pooling layer 404, and a second dense layer 408 after the first dense layer 406. In the depicted embodiment, each node of the second dense layer 408 corresponds to a different classification/label/category 410. In this example, the set of available categories includes “CMC” (relating, for example, to manufacturing and controls of drug substance and drug product materials), “Clinical” (relating, for example, to patients, drug products in the context of patients, or devices in the context of patients), “Regulatory” (relating, for example, to regulatory or administrative spaces), “Labeling” (relating, for example, to the labeling of products, languages, and adherence to legal requirements), and “Safety” (relating, for example, to patient safety). The DFF neural network 400 may include one or more additional stages and/or layers not shown in FIG. 4. For example, the DFF neural network 400 may also include a dropout stage immediately after the global max pooling layer 404, an activation layer (e.g., with a tanh or other suitable activation function) immediately after the first dense layer 406, and another dropout stage immediately after the activation layer. In alternative embodiments, the DFF neural network 400 may include more or fewer dense and/or pooling layers than are shown in FIG. 4. However, the relatively low-complexity architecture of FIG. 4 (with only one pooling layer and only two dense layers) can provide results that exceed other DFF neural networks with more or fewer pooling and/or dense layers.

The DFF neural network 400 calculates values for each node of the second dense layer 408 and, in some embodiments, the classification unit 142A determines the classification based on which node of the second dense layer 408 has the highest value. In other embodiments, however, the classification unit 142A does not make a hard decision as to the appropriate classification, and instead outputs data indicative of a soft decision (e.g., by providing some or all of the values calculated by the second dense layer 408 for user inspection/consideration).

To train the DFF neural network 400 (before run-time operation), manually-labeled regulatory questions from the database 126 (and/or elsewhere) may be used, with the questions acting as inputs/features and the manual labels acting as training labels. By virtue of its simplicity, the DFF neural network 400 can be trained and validated, and perform classification, far faster (e.g., by an order of magnitude or more) than other classification models (e.g., bidirectional neural networks).

Performance of the DFF neural network 400 shown in FIG. 4 (i.e., with exactly one global max pooling layer and exactly two dense layers) is shown in FIGS. 5A-C. FIGS. 5A-C show both training and validation results, with the validation results being more representative of the expected run-time performance. As seen in plots 500, 520, and 540 of FIGS. 5A, 5B, and 5C, respectively, the DFF neural network 400 provided accuracy of approximately 80%, loss of approximately 0.62, and recall of approximately 76%. It is understood that accuracy, loss, and recall metrics for such a model need not be very close to the ideal metrics, because questions that are incorrectly classified will eventually be routed to the correct person (e.g., after initially being presented to the incorrect person, or after initially being classified as “Unknown,” etc.), albeit with some additional delay. So long as the metrics are reasonably good, the classifications can save reviewers a very substantial amount of time.

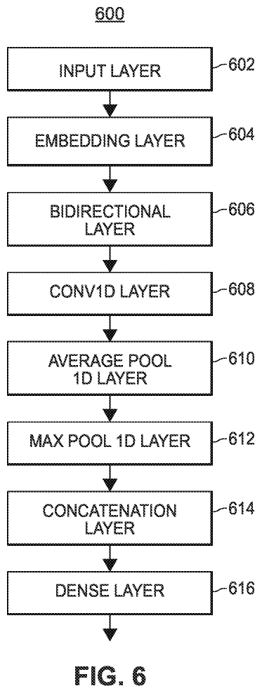

FIG. 6 shows an alternative embodiment in which the NLP model used by the classification unit 142A is, or includes, a bidirectional neural network 600. The example bidirectional neural network 600 of FIG. 6 (e.g., an LSTM neural network) includes an input layer 602 that accepts inputs (e.g., the padded number sequences output at stage 312 of FIG. 3), an embedding layer 604 (e.g., to generate an embedding matrix similar to the embedding matrix 402 from the padded number sequences), a bidirectional layer 606 that implements feedback between layers within the neural network 600, a one-dimensional convolution (Conv1D) layer 608, a one-dimensional average pooling layer 610, a one-dimensional max pooling layer 612, a concatenation layer 614, and a dense layer 616. In other embodiments, the bidirectional neural network 600 may include more or fewer layers and/or stages (e.g., more dense layers, more pooling layers, etc.). While the bidirectional neural network 600 can take significantly more time to train, validate, and run than the DFF neural network 400, the bidirectional neural network 600 may provide better results in some cases (e.g., if many of the questions are relatively long), due to its ability to, in effect, read text both forwards and backwards.

The similarity unit 142B may use an NLP model (of NLP models 130) that is, or includes, a bidirectional neural network. Moreover, the NLP model used by the similarity unit 142B may be a contextualized embedding model (i.e., a model trained to learn embeddings of words based on the context of use of those words). For example, the similarity unit 142B may use a Bidirectional Encoder Representations from Transformers (BERT) model to identify similar documents.

The answer generation unit 142C may use the same NLP model (directly, or by calling similarity unit 142B, etc.) to identify documents similar to a regulatory question, and also uses an additional NLP model (also of NLP models 130) to generate one or more potential answers to the regulatory question based on the identified document(s). This additional NLP model may be a transformer-based language model such as GPT-2, for example, and may be trained using a large dataset such as SQuAD (Stanford Question Answering Dataset). In some embodiments, the NLP model is further trained/refined (by computing system 102 or another computing device/system) using data sources with textual content that is more reflective of the language likely to be found in the regulatory questions/documents. If the regulatory questions pertain to pharmaceuticals (e.g., usage, risks, etc.), for example, the NLP model may be further trained using documents more likely to use terminology pertaining to pharmaceuticals, such as historical HAQs and RTQs, drug patents, and so on. In this manner, the additional NLP model used by the answer generation unit 142C may be better equipped to understand the technical language of the regulatory questions.

The summarizer unit 142D may use yet another NLP model (of the NLP models 130) to generate summaries of the regulatory questions. The NLP model used by the summarizer unit 142D may be, or include, a bidirectional neural network. Moreover, the NLP model used by the summarizer unit 142D may be a contextualized embedding model. For example, the summarizer unit 142D may use a BERT model to generate summaries.

The RDRF application 128 may use an Elasticsearch engine to search the database 126 (or at least, a portion of the database 126 that includes historical regulatory and/or other documents). It has been found that an Elasticsearch engine is particularly accurate and reliable for regulatory documents, due to their sparse data, and because Elasticsearch supports embeddings (which may be used by various NLP models as discussed above).

FIGS. 7A-C depict example user interfaces that may be provided by the system 100 of FIG. 1. More specifically, the web browser application 170 of the client device 104 may present any or all of the user interfaces of FIGS. 7A-C to a user via the display device 164, using data provided to the client device 104 by the RDRF application 128 executing on the computing system 102. Alternatively, the user interfaces of FIGS. 7A-C may be generated entirely at the client device 102 (e.g., in an embodiment where the RDRF application 128 resides at the client device, and where the system 100 does not include the computing system 102).

Referring first to FIG. 7A, an example user interface 700 includes an area 702 in which the text of various questions from regulatory documents can be displayed, along with related information (i.e., in this example, the classification of the question such as “Clinical” or “CMC”). The user interface 700 also includes a set of controls 704 that provide the user with various filtering options. Based on the (default or user-configured) settings of the controls 704, the area 702 displays only those questions (from the relevant regulatory document or documents) that meet the specified filter criteria. The “Predicted Label” control enables the user to filter according to any of the classifications of the full set of questions, as made by the classification unit 142A. A text search control enables the user to search the question based on the characters, terms, etc., included within the text of the questions.

Table 1 below provides a more extensive list of example questions, having various classifications, that may be included in the area 702 (e.g., if the user scrolls down a full list of questions). It is understood, however, that the list of Table 1 is still very short compared to most real-world scenarios:

TABLE 1

| Classification | Text |
|---|---|
| Clinical | Provide a statistical assessment of the agreement |
| | between investigators and central review |
| | to better understand the difference. |
| Clinical | A sensitivity analysis on the primary |
| | assessment was only provided with a |
| | complete case analysis. A second method |
| | of handling missing data should be provided. |
| Clinical | As the incident of adverse events is expected to |
| | increase over time, use of patient-years for power |
| | the study and analysis is expected to underestimate |
| | the incident rate of the adverse events. The study |
| | should be powered based on the completers. |
| CMC | Please provide readings for absorbance, weight of |
| | sample and buffer for each sample. |
| CMC | The drug product has a 1.0% degradation specification. |
| | Please confirm that the levels of relevant |
| | impurities are within the levels qualified in |
| | previous pre-clinical or clinical studies. |
| CMC | Evidence should be provided that the collected data |
| | for the batches stability in the prefilled syringes |
| | can be expanded to the rest of the ten dosages. |
| Labeling | There is a carton labeling. The statement with correct |
| | amount of sterile water for reconstitution should |
| | be displayed on the side display panel. |
| | After reconstitution with 5 mL of Sterile Water for |
| | Injection, the concentration of molecule is 2%. The |
| | correct amount of Sterile Water for Injection is |
| | indicated in the Prescribing Information. |
| Labeling | The text of the Summary of Product Characteristics, |
| | Patient Information Leaflet and the text for the outer |
| | and immediate packaging needs to be revised. |
| Labeling | The brand name and common name can be |
| | removed from the back panel to avoid |
| | compromising the white space. |
| Regulatory | The first question asks if the product has a |
| | marketing authorisation or not, and if so, if |
| | it has an orphan designation. |
| Regulatory | The Corrected Certified Product Information Document |
| | should be submitted in both paper and electronic copies. |
| Regulatory | To confirm. molecule is only registered in location, the |
| | location and the location. Is this true?. Is there any |
| | pending registration in other countries?. Please |
| | state the name of the countries. |
| Safety | Unless otherwise justified, adverse events of |
| | special/historical interest that were observed in |
| | patients should be included in section 4.8. |
| | A statement on potential progression to |
| | organization should be included. |
| Safety | Literature search and signal detection were not described. |
| | Literature search intervals should be specified. |
| Safety | All cases in which molecule was used to treat disease |
| | of malignancy should be excluded. |

The example user interface 700 also includes a word distribution bar graph 706 that shows the count of the most frequent words within the full set of questions (or, in some embodiments, the count of the most frequent words within the set of filtered questions), and a predicted label distribution bar graph 710 that shows the count of the most frequent classifications/labels/categories for the full set of questions. The example user interface 700 also includes a word cloud 712 to help the user visually approximate the frequency and number of different of words. It is understood that, in other embodiments, the user interface 700 may display more information (e.g., all questions along with their determined classifications), less information (e.g., no word cloud 712), and/or different information, and/or may display information in a different format (e.g., simple counts instead of the bar graphs 706 and 710).

FIG. 7B depicts another example user interface 720. In the user interface 720, an input field 722 allows a user to input (e.g., type, or cut-and-paste) a regulatory question of interest. A control 724 allows a user to select a type of model or functionality to apply to the question entered in input field 722. In this example, if the user selects “DC” the RDRF application 128 processes the entered question with the classification unit 142A, if the user selects “SS” the RDRF application 128 processes the entered question with the similarity unit 142B, if the user selects “QA” the RDRF application 128 processes the entered question with the answer generation unit 142C (which may also involve processing the question with the similarity unit 142B as discussed above), and if the user selects “SUM” the RDRF application 128 processes the entered question with the summarizer unit 142D. FIG. 7B depicts a scenario where the user has selected “QA.”

Another control 726 allows the user to set a complexity level for the model (e.g., by selecting from among the five discrete complexity levels shown in FIG. 7B). A higher complexity may correspond to a more complex NLP model (e.g., more neural network layers), for example, or may mean that a single NLP model is applied for a longer time. Generally, higher complexity results in more precision, but also more processing time.

An area 730 of the user interface 720 shows similar documents that were identified by the RDRF application 128. In some embodiments, the similar questions are questions identified by the similarity unit 142B, and/or are only shown if the user selects “SS” using control 724. An area 732 of the user interface 720 shows the potential answers generated by the answer generation unit 142C, along with associated information. In this example, area 732 also shows, for each potential answer, the associated confidence score generated by the GPT-2 or other NLP model being used by the answer generation unit 142C, an identifier of the source/document that the answer generation unit 142C used to derive the depicted answer, and “Context” that shows at least a part of the specific text of the document that the answer generation unit 142C used to derive the depicted answer.

A control 734 enables a user to indicate whether the displayed answers are useful/helpful or not useful/helpful (in the example shown, by selecting a “thumbs up” icon or a “thumbs down” icon, respectively). The RDRF application 128, or other software stored on computing system 120 or another system/device, may use feedback data representing the user selection or entry via control 734 to further train/refine one or more of the NLP models 130 that are used by the answer generation unit 142C, e.g., with reinforcement learning. For example, the RDRF application 128 may use the feedback data to further train an NLP model (e.g., a BERT model) used to identify similar documents, and/or to further train another NLP model (e.g., a GPT-2 model) used to generate answers based on the similar documents.

FIG. 7C depicts yet another example user interface 740. The user interface 740 includes an input field 742 and control 744, which may be the same as, or similar to, input field 722 and control 724 of FIG. 7B. The user interface 740 may be the same as the user interface 720 shown in FIG. 7B, for example, but in a different scenario where the user has selected “SS” rather than “QA.”

An area 746 of the user interface 740 shows a number of potential categories/classifications determined by the classification unit 142A, with a confidence score for each. The confidence scores may be the numbers output at the different nodes of the second dense layer 408 of the DFF neural network 400 shown in FIG. 4, for example. An area 752 of the user interface 740 shows information relating to the similar documents identified (in database 126) by the similarity unit 142B. In this example, area 752 also shows, for each identified document, an identifier/name of the document, an identifier (“ID”) of the document, and “Context” that shows at least a part of the specific text of the document that the similarity unit 142B used as a basis for selecting/identifying the document as a “similar” document.

The user interface 740 also includes a control 754 for providing user feedback, which may be similar to control 734 of user interface 720. The RDRF application 128, or other software stored on computing system 120 or another system/device, may use feedback data representing the user selection or entry via control 754 to further train/refine one or more of the NLP models 130 that are used by the similarity unit 142B, e.g., with reinforcement learning. For example, the RDRF application 128 may use the feedback data to further train a BERT model used by the similarity unit 142B to identify similar documents.

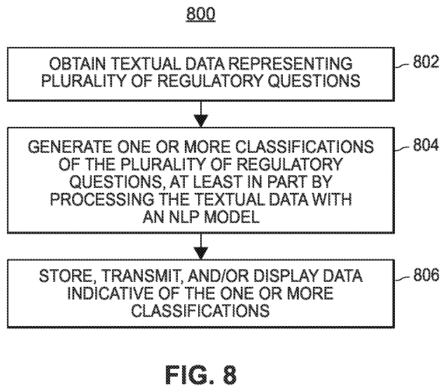

FIGS. 8-11 are flow diagrams of example methods for facilitating responses to regulatory questions. The methods may be implemented by the processing hardware 120 of the computing system 102 when executing the software instructions of the RDRF application 128 stored in the memory 124, for example. In other embodiments, some or all of each method is implemented by the processing hardware 160 of the client device 104 when executing the software instructions of an application stored in the memory 168 (e.g., the web browser application 170, or the RDRF application 128 if the latter resides at the client device 104).

Referring first to FIG. 8, at block 802, textual data representing a plurality of regulatory questions (e.g., questions from one or more regulatory documents) is obtained. Block 802 may be similar to stage 302 of the process 300, for example. At block 804, one or more classifications of the plurality of regulatory questions is/are generated, at least in part by processing the textual data obtained at block 802 with an NLP model. The NLP model may be one of the NLP models 130 of FIG. 1, for example. As more specific examples, the NLP model may be the DFF neural network 400 of FIG. 4 or the bidirectional neural network 600 of FIG. 6.

At block 806, data indicative of the classification(s) is stored, transmitted, and/or displayed. The data may be data derived from the classifications (e.g., a subset of questions corresponding to a particular one of the generated classifications), or may be the classifications themselves. In some embodiments, block 806 includes causing at least a subset of the plurality of regulatory questions to be displayed (e.g., locally or at another computing device) in a manner indicative of the classification(s). For example, block 806 may include causing each regulatory question to be selectively displayed or not displayed based on both a classification (of the classification(s) determined at block 804) that corresponds to the regulatory question, and a user-selected filter setting (e.g., a setting of a control similar to the “Predicted Label” control in the user interface 700 of FIG. 7A). As another example, block 806 may include causing each question of the subset of questions (and possibly all questions) to be displayed in association with the corresponding classification (e.g., such that the classifications generated at block 804 are shown in the user interface 700 of FIG. 7A, or a similar user interface, alongside the corresponding questions).

In some embodiments, the method 800 includes one or more additional blocks not shown in FIG. 8. For example, the method 800 may include an additional block (e.g., occurring after block 802 and before block 804) in which the textual data is pre-processed to remove words and/or characters not to be used for classification, by transforming the word sequences of the regulatory questions into respective number sequences, and/or by padding those number sequences (e.g., any of the operations described above with reference to stages 304, 306, 308, 310, and/or 312 of the process 300 of FIG. 3).

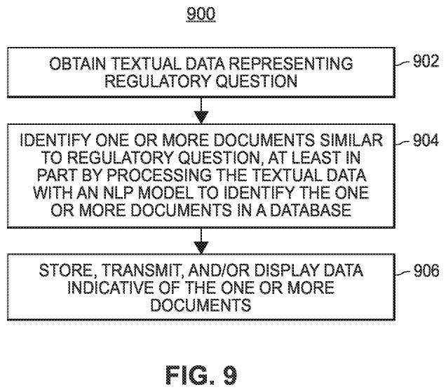

Referring next to FIG. 9, at block 902, textual data representing a regulatory question (e.g., a question from a regulatory document) is obtained. Block 902 may be similar to a portion of stage 302 of the process 300, for example. At block 904, one or more documents similar to the regulatory question is/are identified, at least in part by processing the textual data obtained at block 902 with an NLP model. The NLP model may be one of the NLP models 130 of FIG. 1, for example. As a more specific example, the NLP model may a BERT model, or another bidirectional neural network that supports contextualized embeddings.

At block 906, data indicative of the document(s) is stored, transmitted, and/or displayed. The data may include a name and/or other identifier of each document, and/or the text from the document that caused the NLP model to identify the document as a “similar” document at block 904, for example.

In some embodiments, the method 900 includes one or more additional blocks not shown in FIG. 9. For example, the method 900 may include one or more additional blocks (e.g., occurring after block 902 and before block 904) in which one or more of the pre-processing steps discussed above in connection with the method 800 are applied (e.g., removing irrelevant words and/or characters, transforming word sequences to number sequences, and/or padding the number sequences).

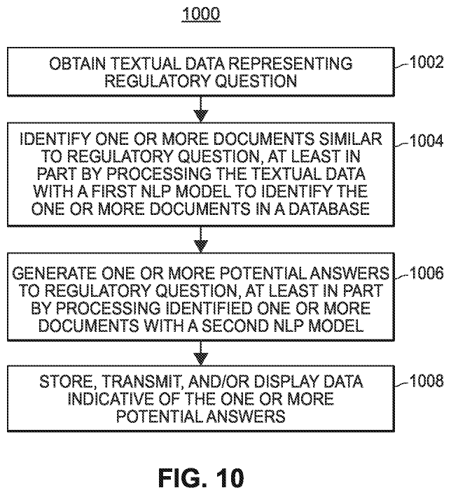

Referring next to FIG. 10, at block 1002, textual data representing a regulatory question (e.g., a question from a regulatory document) is obtained. Block 1002 may be similar to a portion of stage 302 of the process 300, for example. At block 1004, one or more documents similar to the regulatory question is/are identified, at least in part by processing the textual data obtained at block 1002 with a first NLP model. Block 1004 may be similar to block 904 of the method 900, for example.

At block 1006, one or more potential answers to the regulatory question is/are generated, at least in part by processing the document(s) identified at block 1004 with a second NLP model. The second NLP model may be a GPT-2 model, or another suitable bidirectional neural network, for example. At block 1008, data indicative of the potential answer(s) generated at block 1006 is stored, transmitted, and/or displayed. For each potential answer, the data may include the potential answer itself, an identifier of a document from which the potential answer was derived, and/or a portion of text of the document from which the potential answer was derived.

In some embodiments, the method 1000 includes one or more additional blocks not shown in FIG. 10. For example, the method 1000 may include one or more additional blocks (e.g., occurring after block 1002 and before block 1004) in which one or more of the pre-processing steps discussed above in connection with the method 800 are applied (e.g., removing irrelevant words and/or characters, transforming word sequences to number sequences, and/or padding the number sequences). As another example, the method 1000 may include a first additional block in which a confidence score associated with each of the one or more potential answers to the regulatory question is determined, and a second additional block in which data indicative of the confidence score associated with each of the one or more potential answers to the regulatory question is stored, transmitted, and/or displayed. As yet another example, the method 1000 may include a first additional block in which user feedback indicating usefulness of the one or more potential answers is received, and a second additional block in which the user feedback is used to train the first and/or second NLP model.

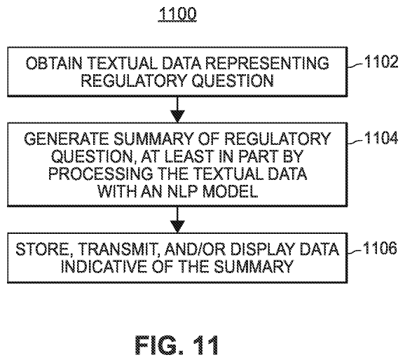

Referring next to FIG. 11, at block 1102, textual data representing a regulatory question (e.g., a question from a regulatory document) is obtained. Block 1102 may be similar to a portion of stage 302 of the process 300, for example. At block 1104, a summary of the regulatory question is generated, at least in part by processing the textual data obtained at block 1102 with an NLP model. The NLP model may be one of the NLP models 130 of FIG. 1, for example. As a more specific example, the NLP model may a BERT model, or another bidirectional neural network that supports contextualized embeddings.

At block 1106, data indicative of the summary is stored, transmitted, and/or displayed. The data may include the summary itself, for example, and possibly associated information such as the name, identifier, and/or portion of one or more documents from which the summary was derived. In some embodiments, the method 1100 includes one or more additional blocks not shown in FIG. 11. For example, the method 1100 may include one or more additional blocks (e.g., occurring after block 1102 and before block 1104) in which one or more of the pre-processing steps discussed above in connection with the method 800 are applied (e.g., removing irrelevant words and/or characters, transforming word sequences to number sequences, and/or padding the number sequences).

The following list of examples reflects a variety of the embodiments explicitly contemplated by the present disclosure:

Example 1. A method for processing regulatory questions, the method comprising: obtaining, by one or more processors, textual data representing a plurality of regulatory questions; generating, by the one or more processors, one or more classifications of the plurality of regulatory questions, at least in part by processing the textual data with a natural language processing model; and storing, transmitting, and/or displaying, by the one or more processors, data indicative of the one or more classifications.

Example 2. The method of example 1, wherein the natural language processing model is a deep feed-forward neural network.

Example 3. The method of example 2, wherein the deep feed-forward neural network includes exactly one global max pooling layer and a plurality of dense layers.

Example 4. The method of example 3, wherein the deep feed-forward neural network includes exactly two dense layers.

Example 5. The method of example 1, wherein the natural language processing model includes at least one bidirectional layer.

Example 6. The method of example 5, wherein the natural language processing model is a long short-term memory (LSTM) model.

Example 7. The method of any one of examples 1-6, further comprising: before processing the textual data with the natural language processing model, pre-processing, by one or more processors, the textual data to remove words and/or characters not to be used for classification.

Example 8. The method of any one of examples 1-7, wherein the plurality of questions corresponds to a plurality of respective word sequences within the textual data, and wherein the method further comprises: before processing the textual data with the natural language processing model, pre-processing, by the one or more processors, the textual data by transforming each of the respective word sequences into a respective number sequence.

Example 9. The method of example 8, wherein the method further comprises: before processing the textual data with the natural language processing model, pre-processing, by the one or more processors, the textual data by padding the respective word sequences such that all vectors representing the respective word sequences have an equal sequence length.

Example 10. The method of any one of examples 1-9, wherein the method comprises: causing, by the one or more processors, at least a subset of the plurality of questions to be displayed in a manner indicative of the one or more classifications.

Example 11. The method of example 10, wherein causing at least the subset of the plurality of questions to be displayed in a manner indicative of the one or more classifications includes: causing each question to be selectively displayed or not displayed based on (i) a classification, of the one or more classifications, that corresponds to the question, and (ii) a user-selected filter setting.

Example 12. The method of example 10, wherein causing at least the subset of the plurality of questions to be displayed in a manner indicative of the one or more classifications includes: causing each question of the subset of the plurality of questions to be displayed in association with the corresponding classification from the one or more classifications.

Example 13. A system comprising: one or more processors; and one or more memories storing instructions that, when executed by the one or more processors, cause the one or more processors to perform the method of any one of examples 1-12.

Example 14. A method for processing regulatory questions, the method comprising: obtaining, by one or more processors, textual data representing a regulatory question; identifying, by the one or more processors, one or more documents that are similar to the regulatory question, at least in part by processing the textual data with a natural language processing model to identify the one or more documents in a database; and storing, transmitting, and/or displaying, by the one or more processors, data indicative of the one or more documents.

Example 15. The method of example 14, wherein the natural language processing model is a neural network.

Example 16. The method of example 14 or 15, wherein the natural language processing model is bidirectional.

Example 17. The method of any one of examples 14-16, wherein the natural language processing model is a contextualized embedding model.

Example 18. The method of any one of examples 14-17, wherein processing the textual data with the natural language processing model to identify the one or more documents in the database includes using an elastic search engine to search the database.

Example 19. The method of any one of examples 14-18, further comprising: before processing the textual data with the natural language processing model, pre-processing, by one or more processors, the textual data to remove words and/or characters not to be used for the identifying.

Example 20. The method of any one of examples 14-19, wherein the method further comprises: before processing the textual data with the natural language processing model, pre-processing, by the one or more processors, the textual data by transforming a word sequence of the textual data into a number sequence.

Example 21. The method of example 20, wherein the method further comprises: before processing the textual data with the natural language processing model, pre-processing, by the one or more processors, the textual data by padding the word sequence such that a vector representing the word sequence has a predetermined sequence length.

Example 22. A system comprising: one or more processors; and one or more memories storing instructions that, when executed by the one or more processors, cause the one or more processors to perform the method of any one of examples 14-21.

Example 23. A method for processing regulatory questions, the method comprising: obtaining, by one or more processors, textual data representing a regulatory question; identifying, by the one or more processors, one or more documents that are similar to the regulatory question, at least in part by processing the textual data with a first natural language processing model to identify the one or more documents in a database; generating, by the one or more processors, one or more potential answers to the regulatory question, at least in part by processing the identified one or more documents with a second natural language processing model; and storing, transmitting, and/or displaying, by the one or more processors, data indicative of the one or more potential answers to the regulatory question.

Example 24. The method of example 23, wherein the first natural language processing model and the second natural language processing model are neural networks.

Example 25. The method of example 23 or 24, wherein the first natural language processing model is bidirectional.

Example 26. The method of any one of examples 23-25, wherein the second natural language processing model is a GPT-2 model.

Example 27. The method of any one of examples 23-26, further comprising: before processing the textual data with the first natural language processing model, pre-processing, by one or more processors, the textual data to remove words and/or characters not to be used for the identifying.

Example 28. The method of any one of examples 23-27, wherein the method further comprises: before processing the textual data with the first natural language processing model, pre-processing, by the one or more processors, the textual data by transforming a word sequence of the textual data into a number sequence.

Example 29. The method of example 28, wherein the method further comprises: before processing the textual data with the first natural language processing model, pre-processing, by the one or more processors, the textual data by padding the word sequence such that a vector representing the word sequence has a predetermined sequence length.

Example 30. The method of any one of examples 23-29, wherein the method further comprises: determining, by the one or more processors, a confidence score associated with each of the one or more potential answers to the regulatory question; and storing, transmitting, and/or displaying, by the one or more processors, data indicative of the confidence score associated with each of the one or more potential answers to the regulatory question.

Example 31. The method of any one of examples 23-30, wherein the method further comprises: for each of the one or more potential answers to the regulatory question, display (i) the potential answer, (ii) an identifier of a document, among the one or more documents, from which the potential answer was derived, and (iii) a portion of text of the document from which the potential answer was derived.

Example 32. The method of any one of examples 23-31, wherein the method further comprises: receiving, by the one or more processors, user feedback indicating usefulness of the one or more potential answers; and using, by the one or more processors, the user feedback to train the first and/or second natural language processing model.

Example 33. A system comprising: one or more processors; and one or more memories storing instructions that, when executed by the one or more processors, cause the one or more processors to perform the method of any one of examples 23-32.

Example 34. A method for processing regulatory questions, the method comprising: obtaining, by one or more processors, textual data representing a regulatory question; generating, by the one or more processors, a summary of the regulatory question, at least in part by processing the textual data with a natural language processing model; and storing, transmitting, and/or displaying, by the one or more processors, data indicative of the summary.

Example 35. The method of example 34, wherein the natural language processing model is a neural network.

Example 36. The method of example 35, wherein the natural language processing model is bidirectional.

Example 37. A system comprising: one or more processors; and one or more memories storing instructions that, when executed by the one or more processors, cause the one or more processors to perform the method of any one of examples 34-36.

Certain embodiments of this disclosure relate to a non-transitory computer-readable storage medium having computer code thereon for performing various computer-implemented operations. Terms such as “computer-readable storage medium” may be used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (“PLDs”), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

As used herein, the singular terms “a,” “an,” and “the” may include plural referents, unless the context clearly dictates otherwise.

As used herein, the terms “connect,” “connected,” and “connection” refer to (and connections depicted in the drawings represent) an operational coupling or linking. Connected components can be directly or indirectly coupled to one another, for example, through another set of components.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to +3%, less than or equal to +2%, less than or equal to +1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes, tolerances and/or other reasons. There may be other embodiments of the present disclosure which are not specifically illustrated. The specification (other than the claims) and drawings are to be regarded as illustrative rather than restrictive. Modifications may be made to adapt a particular situation, material, composition of matter, technique, or process to the objective, spirit and scope of the present disclosure. All such modifications are intended to be within the scope of the claims appended hereto. While the techniques disclosed herein have been described with reference to particular operations performed in a particular order, it will be understood that these operations may be combined, sub-divided, or re-ordered to form an equivalent technique without departing from the teachings of the present disclosure. Accordingly, unless specifically indicated herein, the order and grouping of the operations are not limitations of the present disclosure.

1. A method for processing regulatory questions, the method comprising:
obtaining, by one or more processors, textual data representing a plurality of regulatory questions;
generating, by the one or more processors, one or more classifications of the plurality of regulatory questions, at least in part by processing the textual data with a natural language processing model; and
storing, transmitting, and/or displaying, by the one or more processors, data indicative of the one or more classifications.

2. The method of claim 1, wherein the natural language processing model is a deep feed-forward neural network.

3. The method of claim 2, wherein the deep feed-forward neural network includes exactly one global max pooling layer and a plurality of dense layers.

4. The method of claim 3, wherein the deep feed-forward neural network includes exactly two dense layers.

5. The method of claim 1, wherein the natural language processing model includes at least one bidirectional layer.

6. The method of claim 5, wherein the natural language processing model is a long short-term memory (LSTM) model.

7. The method of claim 1, further comprising:
before processing the textual data with the natural language processing model, pre-processing, by one or more processors, the textual data to remove words and/or characters not to be used for classification.

8. The method of claim 1, wherein the plurality of questions corresponds to a plurality of respective word sequences within the textual data, and wherein the method further comprises:
before processing the textual data with the natural language processing model, pre-processing, by the one or more processors, the textual data by transforming each of the respective word sequences into a respective number sequence.

9. The method of claim 8, wherein the method further comprises:
before processing the textual data with the natural language processing model, pre-processing, by the one or more processors, the textual data by padding the respective word sequences such that all vectors representing the respective word sequences have an equal sequence length.

10. The method of claim 1, wherein the method comprises:
causing, by the one or more processors, at least a subset of the plurality of questions to be displayed in a manner indicative of the one or more classifications.

11. The method of claim 10, wherein causing at least the subset of the plurality of questions to be displayed in a manner indicative of the one or more classifications includes:
causing each question to be selectively displayed or not displayed based on (i) a classification, of the one or more classifications, that corresponds to the question, and (ii) a user-selected filter setting.

12. The method of claim 10, wherein causing at least the subset of the plurality of questions to be displayed in a manner indicative of the one or more classifications includes:
causing each question of the subset of the plurality of questions to be displayed in association with the corresponding classification from the one or more classifications.

13. A system comprising:
one or more processors; and
one or more memories storing instructions that, when executed by the one or more processors, cause the one or more processors to:
obtain textual data representing a plurality of regulatory questions;
generate one or more classifications of the plurality of regulatory questions, at least in part by processing the textual data with a natural language processing model; and
store, transmit, and/or display data indicative of the one or more classifications.

14. The system of claim 13, wherein the natural language processing model is a deep feed-forward neural network.

15. The system of claim 14, wherein the deep feed-forward neural network includes exactly one global max pooling layer and a plurality of dense layers.

16. The system of claim 15, wherein the deep feed-forward neural network includes exactly two dense layers.

17. The system of claim 13, wherein the natural language processing model includes at least one bidirectional layer.

18. The system of claim 17, wherein the natural language processing model is a long short-term memory (LSTM) model.

19. The system of claim 13, wherein the plurality of questions corresponds to a plurality of respective word sequences within the textual data, and wherein the instructions, when executed, cause the one or more processors to:
before processing the textual data with the natural language processing model, pre-process the textual data by transforming each of the respective word sequences into a respective number sequence.

20. The system of claim 19, wherein the instructions, when executed, cause the one or more processors to:
before processing the textual data with the natural language processing model, pre-process the textual data by padding the respective word sequences such that all vectors representing the respective word sequences have an equal sequence length.
